(19) United States
(12) Patent Application Publication
(10) Pub. No.: US 2019/0028010 A1
(43) Pub. Date: Jan. 24, 2019

(54) VIBRATION MOTOR AND PORTABLE DEVICE

(71) Applicant: Goertek Inc., Shandong (CN)

(72) Inventors: Yueguang Zhu, Shandong (CN); Xinzhong Zhang, Shandong (CN)

(21) Appl. No.: 16/145,147

(22) Filed: Sep. 27, 2018

Related U.S. Application Data
(63) Continuation of application No. PCT/CN2016/082844, filed on May 20, 2016.

(30) Foreign Application Priority Data
Mar. 28, 2016 (CN) 201610184100.3

(51) Int. Cl. H02K 33/02

(52) U.S. Cl. CPC H02K 33/02

(57) ABSTRACT

The present invention discloses a vibration motor and a portable device. The vibration motor comprises: a housing; a vibration system disposed in the cavity, and comprising a vibrator and an elastic sheet, the vibrator being provided with a magnetic gap and the elastic sheet having a fixing portion and a plurality of cantilevers, a through hole being arranged in a middle portion of the fixing portion, the cantilevers being formed by spirally extending the fixing portion along the central axis direction of the fixing portion, the cantilevers being gradually expanded, the fixing portion being fixedly connected with the vibrator, and the ends of the cantilevers being fixedly connected with the housing; and a coil arranged in the cavity, one end of the coil being fixedly connected with the lower housing, and the other end of the coil being inserted into the magnetic gap.

### CROSS-REFERENCE TO RELATED APPLICATIONS

Pursuant to 35 U.S.C. § 365(c), this application is a continuation of International Application No. PCT/CN2016/082844, filed on May 20, 2016, which claims priority to Chinese Patent Application No. 201610184100.3, filed on Mar. 28, 2016, both of which are hereby incorporated by reference in their entireties.

### TECHNICAL FIELD

The present invention relates to the technical field of vibration devices, and in particular, to a flat linear vibration motor and a portable device to which the vibration motor is applied.

### BACKGROUND

An existing linear vibration motor generally comprises a housing. A coil, a vibrator, and an elastic sheet are disposed in an inner cavity of the housing. The coil and the elastic sheet are arranged on two opposite sides of the vibrator. One end of the coil is fixed on the housing, and the other end of the coil is inserted into the magnetic gap of the vibrator; one end of the elastic sheet is fixedly connected with the vibrator, and the other end of the elastic sheet is in vibrating connection with the housing. The side-by-side arrangement of the coil, the vibrator, and the elastic sheet occupies the vibration space and increases the volume of the linear vibration motor, making it difficult to implement a light, thin, and miniature motor. In addition, in the prior art (as shown in FIG. 4), the structure of the elastic sheet generally comprises a fixing portion 701, a cantilever 702 and an annular spring frame 704. The fixing portion and the annular spring frame are coaxially arranged. The cantilever 702 is in a spiral shape. One end of the cantilever 702 is connected to the fixing portion, and the other end is connected to the annular spring frame. The fixing portion 701 is fixedly connected to the vibrator, and the annular spring frame 704 is fixedly connected to the housing. Since the annular spring frame 704 occupies the extension space of the cantilever 702, the radial space utilization rate of the cantilever 702 is low, the polarization tendency of the motor is large, and the vibration effect is poor. Therefore, it is necessary to provide a new vibration motor whose elastic sheet does not have the above annular spring frame 704 so as to increase the radial extension space and radial space utilization rate of the cantilever 702 increase the radius of the spring fixing portion, expand the first order and second order vibration frequency difference of the vibration motor and reduce the probability of deflection.

### SUMMARY

An object of the present invention is to provide a new technical solution of a vibration motor.

According to a first aspect of the present invention, a vibration motor is provided, comprising:
a housing, comprising an upper cover and a lower housing connected to each other, wherein a cavity is disposed inside the housing;
a vibration system arranged in the cavity, and comprising a vibrator and an elastic sheet, wherein the vibrator is provided with a magnetic gap, the elastic sheet has a fixing portion and a plurality of cantilevers, a through hole is provided in a middle portion of the fixing portion, the cantilever is formed by spirally extending the fixing portion along a central axis direction of the fixing portion, the cantilever gradually expands, the fixing portion is fixedly connected with the vibrator, and an end of the cantilever is fixedly connected with the housing; and
a coil arranged inside the cavity, one end of the coil being fixedly connected with the lower housing, and the other end of the coil being inserted into the magnetic gap.

Preferably, the elastic sheet is arranged between the lower housing and the vibrator or the elastic sheet is arranged between the upper cover and the vibrator.

Preferably, the cantilever is formed by spirally extending the edge of the fixing portion along the central axis direction of the fixing portion, the cantilever is co-planar with the fixing portion, or the cantilever has a height difference in the direction of the central axis of the fixing portion.

Preferably, a plurality of the cantilevers is evenly distributed.

Preferably, the elastic sheet is made of metal.

Preferably, the elastic sheet is integrally formed.

Preferably, an FPCB is further included, the FPCB is fixedly connected with the lower housing, and the coil is in signal connection with the external circuit through the FPCB.

Preferably, the vibrator comprises a magnet, a frame, and a weight block. The frame has a bottom, a side wall portion, and an inner cavity enclosed by the bottom and the side wall portion. The magnet is arranged in the inner cavity. A magnetic gap is provided with between the magnet and the side wall portion, and the weight block sleeves the outside surface of the frame. The fixing portion is annular and the fixing portion is in a fixed connection with the weight bock. The frame is located within a range enclosed by the fixing portion.

Preferably, the height of the frame along the vibration direction is greater than the thickness of the weight block, and a penetration hole communicating the cavity with the outside space is arranged at a position corresponding to the frame, of the upper cover. The inner diameter size of the penetration hole is greater than or equal to the outer diameter size of the frame.

According to a second aspect of the present invention, a portable device is provided. The device comprises a vibration motor provided by the present invention.

The inventor of the present invention finds that in the prior art, since the elastic sheet is provided with an annular spring frame, the expansion of the elastic sheet in a radial direction when being compressed is limited, and the vibration easily causes deflection of the vibrator, thereby affecting the vibration effect. Therefore, the technical task to be accomplished or the technical problem to be resolved in the present invention has never been conceived of or anticipated by a person skilled in the art, and therefore the present invention is a new technical solution.

According to the vibration motor provided by the invention, the cantilever of the elastic sheet is directly and fixedly connected with the lower housing, so that the radial space utilization rate is improved, the first-order and the second-order vibration frequency difference of the vibration motor is expanded, and the polarization of the vibration motor is greatly reduced.

Other features and advantages of the present invention will become apparent from the following detailed description of exemplary embodiments of the present invention with reference to the accompanying drawings.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 is an exploded view of a vibration motor according to an embodiment of the present invention.

FIG. 2 is a sectional view of a vibration motor according to an embodiment of the present invention.

FIG. 3 is a schematic diagram of an elastic sheet according to an embodiment of the present invention.

FIG. 4 is a schematic structural view of an elastic sheet in the prior art.

In the drawings, the following reference numerals represent the following members: 1: upper cover; 101: penetration hole; 102: cavity; 2: lower housing; 3: weight block; 4: frame; 401: bottom; 402: side wall portion; 5: magnet; 501: magnetic gap; 6: washer; 7: elastic sheet; 701: fixing portion; 702: cantilever; 7021: tail end; 703: through hole: 704: annular spring frame; 8: coil; 9: FPCB.

### DETAILED DESCRIPTION

Various exemplary embodiments of the present invention will now be described in detail with reference to the accompanying drawings. It should be noted that the relative arrangement, numerical expressions and numerical values of the components and steps arrange forth in these examples do not limit the scope of the present invention unless otherwise specified.

The following description of at least one exemplary embodiment is in fact merely illustrative and is in no way intended as a limitation to the present invention and its application or use.

Techniques, methods, and apparatus known to those of ordinary skill in the relevant art may not be discussed in detail but wherein appropriate, the techniques, methods, and apparatus should be considered as part of the description.

Among all the examples shown and discussed herein, any specific value should be construed as merely illustrative and not as a limitation. Thus, other examples of exemplary embodiments may have different values.

It should be noted that similar reference numerals and letters denote similar items in the accompanying drawings, and therefore, once an item is defined in a drawing, and there is no need for further discussion in the subsequent accompanying drawings.

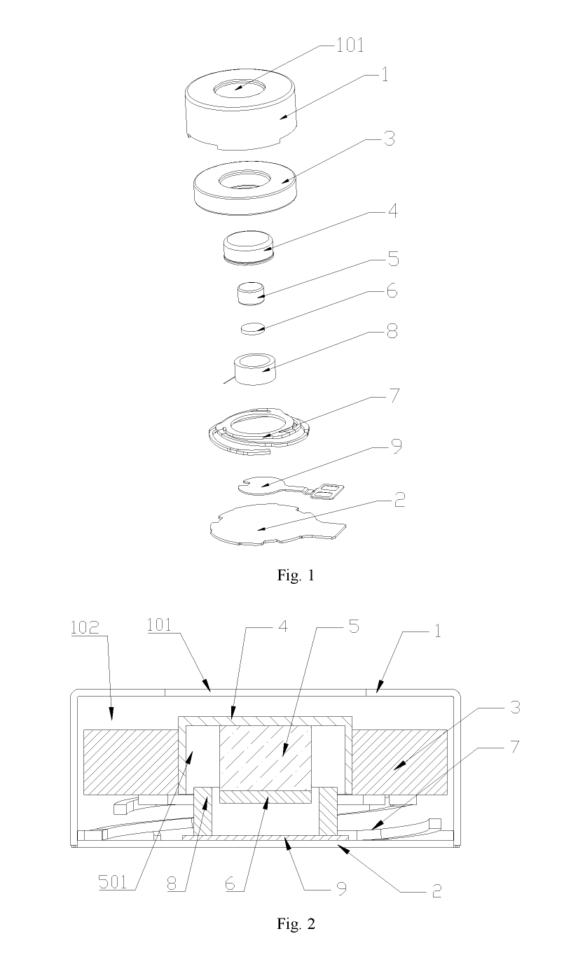

The present invention provides a vibration motor. As shown in FIGS. 1-2, the vibration motor comprises: a housing, a vibration system, and a coil 8. The housing is formed of an upper cover 1 and a lower housing 2 connected to each other in a manner such as buckling, bonding, bolt connection or welding well known to a person skilled in the art. In some examples, the material of the housing is generally metal, plastic, plastic cement, or silica gel. The lower housing 2 is a sheet, the upper cover 1 has a hollow structure and an open end, and the lower housing 2 is arranged at the open end of the upper cover 1. A cavity 102 is formed inside the housing and accommodates the vibration system and the coil 8.

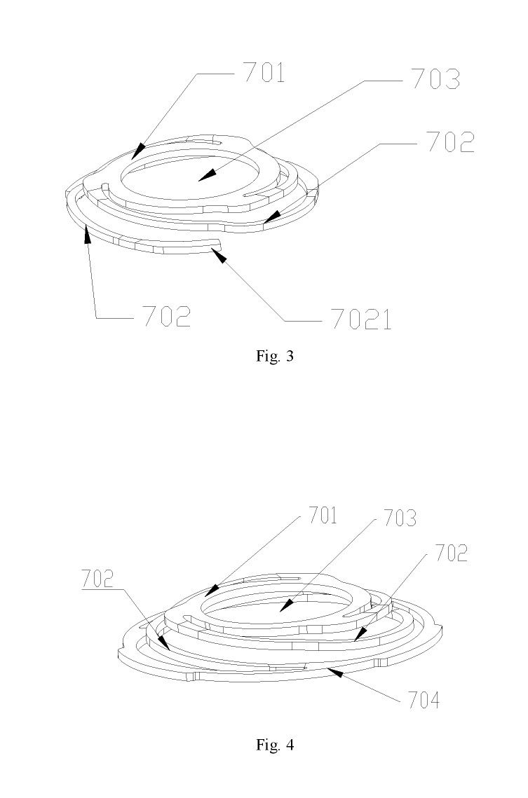

As shown in FIGS. 1 and 3, the vibration system comprises a vibrator and an elastic sheet 7. The vibrator vibrates in the vibration space inside the cavity 102, and is provided with a magnetic gap 501. The elastic sheet 7 is generally made of an elastic material. The material of the elastic sheet 7 may be metal, plastic, or the like. The elastic sheet 7 is used to generate a resilient force to the vibrator. The elastic sheet 7 has a fixing portion 701 and a cantilever 702. A through hole 703 is formed in a middle portion of the fixing portion 701. The cantilever 702 is formed by spirally extending the fixing portion 701 along the central axis direction of the fixing portion, and the cantilever 702 gradually expands. That is, as the displacement of the fixing portion 701 in the central axis direction increases, the distance between the cantilever 702 and the central axis also gradually increases. The shape of the elastic sheet 7 is a trumpet mouth gradually enlarged from the fixing portion 701 to the tail end 7021 of the cantilever 702. The central axis is an imaginary axis that is perpendicular to the fixing portion 701 and located at the center of the fixing portion 701. The elastic sheet 7 extends and contracts along the central axis and drives the vibrator to vibrate. Therefore, the vibrator vibrates in the direction along the central axis.

In other examples, for example, the cantilever 702 of the elastic sheet 7 are coplanar with the fixing portion 701, and the elastic sheet 7 is arranged in a structure similar to a flat spring, which further saves space in the height direction. For example, the cantilever 702 of the elastic sheet 7 has a height difference in the direction of the central axis of the fixing portion 701.

In order to improve the rebounding effect and facilitate the processing of the elastic sheet 7, there is provided with a plurality of cantilevers 702. The cantilever 702 is formed by spirally extending the edge of the fixing portion 701 along the central axis direction of the fixing portion, and the cantilever 702 gradually expands and is uniformly distributed at the fixing portion 701. The tail ends 7021 are also evenly distributed on the circumference where they are located. Moreover, such a structure does not occupy the space of the fixing portion 701 in other places. Considering a wide range of sources, the elastic sheet 7 can be selected from metal plates or sheets, such as SS301, SS304, SS316 stainless steel or copper alloy, etc., and can be integrally formed in a manner well known to those skilled in the art, such as press forming, laser cutting, plasma cutting or the like. It can be understood that, since the elastic sheet 7 is made of metal, in order to provide the elastic sheet 7 with a set stiffness coefficient, the elastic sheet 7 should be heat-treated after molding. Of course, when the requirement on the stiffness coefficient of the elastic sheet 7 is not high, the elastic sheet 7 can be processed by using a plastic material by means of injection molding, for example, and the elastic sheet 7 can be injection-molded according to a set structure.

In the present embodiment, the elastic sheet 7 and the coil 8 are arranged between the lower housing 2 and the vibrator, wherein the fixing portion 701 is fixedly connected to the vibrator, that is, fixedly connected to the vibrator via a surface of the fixing portion 701 opposite to the cantilever 702, and the tail end 7021 of the cantilever 702 is fixedly connected to the lower housing 2. The fixed connection between the elastic sheet 7 and the vibrator, and between the elastic sheet 7 and the lower housing 2 can be achieved by means well known to those skilled in the art, such as welding, bonding, snap-fit or the like. The coil 8 is located in the space enclosed by the elastic sheet 7, one end of the coil 8 is fixedly connected with the lower housing 2, and the other end of the coil 8 is inserted into the magnetic gap 501 through the through hole 703 of the fixing part 701. It can be understood that the area occupied by the fixing portion 701 after the connection is completed is smaller than the area occupied by the tail end 7021 of the cantilever 702. The connection between the vibrator and the fixing portion 701 may cause the support space of the vibrator to be larger relative to the lower housing 2, and the vibrator may not be polarized easily. Of course, in some examples, the fixing portion 701 may be fixedly connected to the lower housing 2. The tail end 7021 of the cantilever 702 is fixedly connected to the vibrator. In this structure, the vibrator has a small support space and is prone to polarization.

The coil 8 is in signal connection to an external circuit, and the coil 8 can be directly connected to an external circuit through a lead. In order to make the signal connection more stable, as shown in FIG. 2, in a preferred embodiment of the present invention, the vibration motor is further provided with an FPCB 9. The coil 8 is in signal connection with the external circuit through the FPCB 9. Specifically, the FPCB 9 is in a sheet-like structure provided with internal pads for signal connection with the coil 8 and external pads for signal connection with external circuits. The FPCB 9 is fixedly connected to the lower housing 2, and can be fixedly connected by means of bonding or welding. The coil 8 is fixedly connected to the FPCB 9, and a fixed connection with the lower housing 2 is realized through the FPCB 9. Of course, the coil 8 can also be directly and fixedly connected to the lower housing 2. At this time, the main part of the FPCB 9 is located within the range enclosed by the coil 8. The leads of the coil 8 may be soldered to the internal pads of the FPCB 9 by tin soldering. The portion of the FPCB 9 provided with the external pads is located outside the housing, and the external pads are in signal connection to the external circuit. The coil 8 realizes a signal connection with an external circuit through the circuit layout on the FPCB 9.

The coil 8 in this structure and the elastic sheet are arranged on the same side of the vibrator, and the space occupied by the two in the vibration direction overlaps, which greatly saves the internal space of the vibration motor, reduces the volume of the vibration motor, and conforms to the development trend of a light, thin, and miniature motor. In addition, the tail end 7021 of the elastic sheet 7 is directly connected with the lower housing 2 in a fixed way. This structure makes the cantilever 702 of the elastic sheet 7 occupy more space in the radial direction and improves the utilization rate of the radial space. The so-called radial direction refers to the direction perpendicular to the central axis, and the improvement in the radial space utilization rate can make the vibrator more steady and less easily to deflect when vibrating, and expand the first-order and second-order vibration frequency difference of the vibration motor, which greatly reduces the polarization of the vibration motor, and improves the vibration effect.

The vibrator may have a variety of structural forms. In a specific embodiment of the present invention, as shown in FIGS. 1-2, the vibrator comprises a frame 4, a magnet 5, and a weight block 3. The frame 4 comprises a bottom 401, a side wall portion 402, and an inner cavity enclosed by the bottom 401 and the side wall portion 402. The magnet 5 is arranged in the inner cavity. A magnetic gap 501 is arranged between the magnet 5 and the side wall portion 402. The weight block 3 is annular and sleeves the outside surface of the side wall portion 402. The frame 4, the magnet 5, and the weight block 3 can be fixedly connected by means well known to those skilled in the art, such as bonding. The magnet 5 may be but is not limited to a ferrite magnet and a neodymium-iron-boron magnet. The frame 4 is a magnetic material, such as iron. In this structure, the frame 4 and the magnet 5 constitute an outer magnetic structure. It is also possible that the frame 4 and the magnet 5 are arranged with an internal magnetic structure as long as a stable uniform magnetic field can be formed. The fixing portion 701 is annular, and the fixing portion 701 is fixedly connected to the weight block 3, and the frame 4 is located within a range enclosed by the fixing portion 701.

Further, in order to make the uniform magnetic field in the magnetic gap 501 more stable and improve the vibration effect of the vibrator, as shown in FIG. 2, the magnet 5 is further arranged with a washer 6 on one side closer to the lower housing 2. The washer 6 has a magnetic conduction effect and can concentrate magnetic force lines onto the magnetic gap 501 and make the direction of the magnetic force lines perpendicular to the vibration direction of the vibrator.

Still further, in a specific embodiment of the present invention, the height of the frame 4 in the vibration direction is greater than the thickness of the weight block 3. A penetration hole 101 is arranged at a position corresponding to the frame 4, of the upper cover 1, and the penetration hole 101 communicates between the cavity 102 and the outside space. The inner diameter size of the penetration hole 101 is larger than the outer diameter size of the frame 4. When vibrating, the portion of the frame 4 protruding from the weight block 3 can pass through the penetration hole 101. The arrangement of the penetration hole 101 increases the vibration space without changing the size of the original housing. This structure is more suitable for the vibrator with a large vibration amplitude.

When the vibration motor is in operation, the vibration signal of the external circuit is transmitted to the coil 8 through the circuit layout of the FPCB 9. After the coil 8 is powered on, it is subjected to the magnetic field force in the uniform magnetic field of the magnetic gap 501. Since the coil 8 is fixedly connected to the lower housing 2, the coil 8 does not vibrate, but the coil 8 gives a counter acting force to the vibrator to make the vibrator vibrate. Since the magnetic force received by the coil 8 is in the direction cutting the magnetic force lines, the vibrator linearly vibrates perpendicularly to the plane where the coil 8 is wound. Since the magnetic field force received by the vibrator and the elastic force of the elastic sheet 7 are all along the direction of the central axis, the vibration direction is along the direction of the central axis.

In order to increase inertia to improve a vibration effect, the vibrator is also arranged with a weight block 3 which is a high-density material such as a heavy metal, a ceramic, or the like. Preferably, the material of the weight block 3 is a metal material such as tungsten steel or stainless steel. The vibrator is fixedly connected with the elastic sheet 7, and the elastic sheet 7 is similar to a spring. When the elastic sheet 7 is compressed or stretched, it will tend to return to the initial position, and the elastic sheet 7 will generate an elastic force. According to Hooke's law, it can be understood that the more the elastic sheet 7 deviates from the initial position, the greater the elastic force is. The elastic force further acts on the vibrator. Therefore, when the vibrator vibrates, the vibrator is subjected to the action of the magnetic field force and the elastic force of the elastic sheet 7. The existence of the two kinds of forces causes the vibrator to vibrate within the set displacement range.

In other examples, the coil 8 is arranged between the lower housing 2 and the vibrator. The elastic sheet 7 is arranged between the vibrator and the upper cover 1. The coil 8, the vibrator, and the elastic sheet are coaxially arranged. This structure takes up more space.

The present invention further provides a portable device, which can be an electronic device such as a mobile phone, a smart watch, a tablet computer, a notebook computer, or the like. The portable device comprises the vibration motor provided by the invention and has the characteristics of a good vibration effect and light and thin appearance.

While certain specific embodiments of the present invention have been illustrated by way of example, it will be understood by those skilled in the art that the foregoing examples are provided for the purpose of illustration and are not intended to limit the scope of the present invention. It will be understood by those skilled in the art that the foregoing embodiments may be modified without departing from the scope and spirit of the present invention. The scope of the present invention is subject to the attached claims.

1. A vibration motor, comprising:
a housing, comprising an upper cover and a lower housing connected to each other, a cavity being arranged inside the housing;
a vibration system, arranged in the cavity, and comprising a vibrator and an elastic sheet, wherein the vibrator is provided with a magnetic gap, the elastic sheet has a fixing portion and a plurality of cantilevers, a through hole is provided in a middle portion of the fixing portion, the cantilever is formed by spirally extending the fixing portion along a central axis direction of the fixing portion, the cantilever gradually expands, the fixing portion is fixedly connected with the vibrator, and an end of the cantilever is fixedly connected with the housing; and
a coil provided inside the cavity, one end of the coil being fixedly connected with the lower housing, and the other end of the coil being inserted into the magnetic gap.

2. The vibration motor according to claim 1, wherein the elastic sheet is disposed between the lower housing and the vibrator or the elastic sheet is disposed between the upper cover and the vibrator.

3. The vibration motor according to claim 1, wherein the cantilever is formed via an edge of the fixing portion spirally extending along the central axis direction of the fixing portion, and the cantilever is co-planar with the fixing portion or the cantilever has a height difference in the central axis direction of the fixing portion.

4. The vibration motor according to claim 3, wherein a plurality of the cantilevers is uniformly distributed.

5. The vibration motor according to claim 1, wherein a material of the elastic sheet is metal.

6. The vibration motor according to claim 1, wherein the elastic sheet is integrally formed.

7. The vibration motor according to claim 1, further comprising an FPCB fixedly connected with the lower housing, the coil being in signal connection with an external circuit through the FPCB.

8. The vibration motor according to claim 1, wherein the vibrator comprises a magnet, a frame, and a weight block; the frame has a bottom, a side wall portion and an inner cavity enclosed by the bottom and the side wall portion; the magnet is disposed in the inner cavity, a magnetic gap is arranged between the magnet and the side wall portion, and the weight block sleeves the outside surface of the frame; and the fixing portion is annular, the fixing portion is fixedly connected to the weight block, and the frame is located within a range enclosed by the fixing portion.

9. The vibration motor according to claim 8, wherein the height of the frame in a vibration direction is greater than the thickness of the weight block, a penetration hole communicating between the cavity and the outside space is arranged at a position corresponding to the frame, of the upper cover, and an inner diameter size of the penetration hole is greater than or equal to an outer diameter size of the frame.

10. A portable device, comprising a vibration motor according to claim 1.
